(19) United States
(12) Patent Application Publication
(10) Pub. No.: US 2025/0202057 A1
(43) Pub. Date: Jun. 19, 2025

(54) SEPARATOR FOR ELECTROCHEMICAL DEVICE, MATERIAL AND ELECTROCHEMICAL DEVICE

(71) Applicant: Sumitomo Chemical Company, Limited, Tokyo (JP)

(72) Inventors: Eri OKANISHI, Niihama-shi (JP); Koki SUWA, Niihama-shi (JP)

(21) Appl. No.: 18/977,091

(22) Filed: Dec. 11, 2024

(30) Foreign Application Priority Data
Dec. 13, 2023 (JP) 2023-210501
Jun. 13, 2024 (JP) 2024-096197

(51) Int. Cl. H01M 50/449; H01G 11/52; H01M 50/417; H01M 50/423

(52) U.S. Cl. CPC H01M 50/449; H01G 11/52; H01M 50/417; H01M 50/423

(57) ABSTRACT

Provided is a separator for an electrochemical device which separator improves a cycle characteristic of an electrochemical device. The separator of the present disclosure includes a porous layer that contains a resin and is such that a value expressed by the following formula (1) is less than 0.05:

$$C / ( A \times B ) \qquad ( 1 )$$

where A is a resin content [% by weight] in the porous layer, B is a porosity [%] of the porous layer, and C is an air permeability [sec/100 mL] of the separator.

This Nonprovisional application claims priority under 35 U.S.C. § 119 on Patent Application No. 2023-210501 filed in Japan on Dec. 13, 2023 and Patent Application No. 2024-096197 filed in Japan on Jun. 13, 2024, the entire contents of which are hereby incorporated by reference.

### TECHNICAL FIELD

The present invention relates to a separator for an electrochemical device (hereinafter referred to as a “separator”), a material for an electrochemical device (hereinafter referred to as a “material”), and an electrochemical device.

### BACKGROUND ART

Electrochemical devices, e.g., nonaqueous electrolyte secondary batteries, particularly lithium ion secondary batteries, have a high energy density, and are therefore widely used as batteries for personal computers, mobile telephones, portable information terminals, cars, and the like.

As a material of such a nonaqueous electrolyte secondary battery, a separator having excellent heat resistance is under development. For example, as in Patent Literature 1, a separator is known in which a heat-resistant layer containing an aramid resin and inorganic particles is formed on a porous substrate.

### CITATION LIST

### Patent Literature

### [Patent Literature 1]

International Publication No. WO 2019/176421

### SUMMARY OF INVENTION

### Technical Problem

However, an electrochemical device including the conventional separator in which a porous layer that is a heat-resistant layer is formed on a porous substrate, such as the separator disclosed in Patent Literature 1, has room for improvement in terms of a cycle characteristic. An aspect of the present invention has an object to provide a separator that enables improvement of a cycle characteristic of an electrochemical device.

### Solution to Problem

The inventors of the present invention conducted diligent studies in order to attain the above object, and consequently found that an electrochemical device including a separator which includes a porous layer and in which a resin proportion of the porous layer, a porosity of the porous layer, and an air permeability of the separator satisfy a specific relation has an excellent cycle characteristic.

A separator for an electrochemical device in accordance with an aspect of the present invention includes a porous layer that contains a resin, wherein a value expressed by the following formula (1) is less than 0.05:

$$C / ( A \times B ) \qquad ( 1 )$$

where A is a resin content [% by weight] in the porous layer, B is a porosity [%] of the porous layer, and C is an air permeability [sec/100 mL] of the separator.

### Advantageous Effects of Invention

An aspect of the present invention makes it possible to provide a separator that enables improvement of a cycle characteristic of an electrochemical device.

### DESCRIPTION OF EMBODIMENTS

The following description will discuss embodiments of the present invention. Note, however, that the present invention is not limited to the embodiments. Any numerical range expressed as “A to B” herein means “not less than A and not more than B” unless otherwise stated.

### [1. Separator]

A separator in accordance with an embodiment of the present invention includes a porous layer that contains a resin, wherein a value expressed by the following formula (1) is less than 0.05:

$$C / ( A \times B ) \qquad ( 1 )$$

where A is a resin content [% by weight] in the porous layer, B is a porosity [%] of the porous layer, and C is an air permeability [sec/100 mL] of the separator.

Hereinafter, the “separator in accordance with an embodiment of the present invention” is also referred to simply as a “separator”. Further, the “resin content in the porous layer” is a resin content with respect to a total weight of the porous layer and is, to put it another way, “a resin content in 100% by weight of the porous layer”.

The value expressed by the formula (1) becomes low when A is high, and/or B is high, and/or C is low. In the separator, the value expressed by the formula (1) is controlled so as to be a value as low as less than 0.05. Thus, the separator has a structure in which the resin content in the porous layer is high, and/or the porous layer has a high porosity, and/or the separator has low air permeability. Note that, in the present specification, the air permeability represents a value as measured by the Gurley tester method in conformity with JIS P8117.

A porous layer having a high resin content provides a high degree of adhesion to an electrode. Such a porous layer and a separator including the porous layer each have high conformability to expansion and shrinkage of an electrode which occur during an operation. Here, in an electrochemical device, it is known that the growth of dendrites during the operation is one of the factors which contribute to a decrease in cycle characteristic. It is also known that the growth of dendrites is caused by a local reaction of cations such as lithium ions (Li⁺) on an electrode in a surface direction thereof during the operation. Here, in a case where a separator has high conformability to the expansion and shrinkage of an electrode, a reaction of cations during the operation occurs evenly on an electrode in a surface direction thereof, and a local reaction of the cations on an electrode in a surface direction thereof is prevented or reduced. Thus, in a case where a porous layer has a high resin content, the growth of dendrites is inhibited in an electrochemical device which includes a separator including such a porous layer. As a result, a cycle characteristic is improved.

In a case where a porous layer has a high porosity, such a porous layer and a separator including the porous layer each have a high liquid retention property. The liquid retention property indicates a property of retaining an electrolyte. Here, in a case where a separator has a high liquid retention property, the occurrence of drying-out after repeated charge-discharge cycles and the occurrence of a local reaction of cations on an electrode in a surface direction thereof which results from the drying-out are prevented or reduced in an electrochemical device which includes such a separator. As a result, in a case where a porous layer has a high porosity, as in the case where a resin content in a porous layer is high, the growth of dendrites is inhibited in an electrochemical device which includes a separator including such a porous layer. As a result, a cycle characteristic is improved.

A separator having low air permeability has low resistance. Here, in a case where a separator has low resistance, overvoltage after repeated charge-discharge cycles is less likely to occur in an electrochemical device including such a separator. Thus, a decrease in battery performance which results from breakage caused by the overvoltage is less likely to occur. As a result, a cycle characteristic of an electrochemical device which includes such a separator is improved.

As described above, the separator has a structure in which a resin content in a porous layer is high, and/or the porous layer has a high porosity, and/or the separator has low air permeability. Thus, it is possible to improve a cycle characteristic of an electrochemical device which includes such a separator.

The value expressed by the formula (1) is preferably a low value from the viewpoint of more suitably improving a cycle characteristic of an electrochemical device which includes the above-described separator. Specifically, the value expressed by the formula (1) is preferably not more than 0.048 and more preferably not more than 0.046. Further, the value expressed by the formula (1) may be not less than 0.01 or may be not less than 0.02.

The separator is preferably such that a value expressed by the following formula (2) is a low value:

$$C / A \qquad ( 2 )$$

where A and C are identical to A and C in the formula (1).

A value expressed by the formula (2) being low means that the separator has a structure in which A is high, and/or C is low. Thus, in a case where the value expressed by the formula (2) is low, the value expressed by the formula (1) is adjusted to a lower value. As a result, it is possible to further improve a cycle characteristic of an electrochemical device which includes the above-described separator. From the aforementioned viewpoint, the value expressed by the formula (2) is preferably less than 3 and more preferably not more than 2.8. Further, the value expressed by the formula (2) may be not less than 0.5 or may be not less than 1.

The separator is preferably such that a value expressed by the following formula (3) is a high value:

$$A \times B \qquad ( 3 )$$

where A and B are identical to A and B in the formula (1).

A value expressed by the formula (3) being high means that the separator has a structure in which A is high, and/or B is high. Thus, in a case where the value expressed by the formula (3) is high, the value expressed by the formula (1) is adjusted to a lower value. As a result, it is possible to further improve a cycle characteristic of an electrochemical device which includes the above-described separator. From the aforementioned viewpoint, the value expressed by the formula (3) is preferably more than 5200, more preferably not less than 5500, still more preferably more than 5500, and particularly preferably not less than 5900. Further, the value expressed by the formula (3) may be not more than 9000 or may be preferably not more than 8000.

From the viewpoint of adjusting the value expressed by the formula (1) to a lower value and further improving a cycle characteristic of an electrochemical device which includes the above-described separator, the above-described A is preferably higher. In addition, from a viewpoint similar to the above-described viewpoint, the above-described B is preferably higher. Furthermore, from a viewpoint similar to the above-described viewpoint, the above-described C is preferably lower.

Specifically, the above-described A, i.e. the resin content in the porous layer, is preferably more than 80% by weight, more preferably not less than 85% by weight, still more preferably not less than 90% by weight, and still more preferably not less than 95% by weight. Further, the resin content in the porous layer with respect to a total weight of the porous layer may be not more than 100% by weight or may be not more than 99% by weight.

In addition, the above-described B, i.e. the porosity of the porous layer, is preferably not less than 55% and more preferably not less than 58%. Further, the porosity of the porous layer may be not more than 90% or may be not more than 80%.

Furthermore, the above-described C, i.e. the air permeability of the separator, is preferably not more than 320 sec/100 mL, more preferably not more than 300 sec/100 mL, and still more preferably not more than 280 sec/100 mL. Further, the air permeability of the separator may be not less than 10 sec/100 mL, may be not less than 25 sec/100 mL, or may be not less than 50 sec/100 mL.

In an embodiment of the present invention, as a material included in an electrochemical device, the porous layer can be provided between a polyolefin porous substrate and at least one of a positive electrode and a negative electrode. Hereinafter, the polyolefin porous substrate is also referred to simply as a “porous substrate”. The porous layer may be provided between the porous substrate and at least one of the positive electrode and the negative electrode in a manner so as to be in contact with the porous substrate and the at least one of the positive electrode and the negative electrode. The number of porous layer(s) provided between the porous substrate and at least one of the positive electrode and the negative electrode may be one, two, or more. The porous layer is preferably an insulating layer.

The porous layer contains a resin. The resin is not limited and includes, for example, a nitrogen-containing resin and a fluorine-containing resin. The nitrogen-containing resin means a resin containing a nitrogen atom (N), and the fluorine-containing resin means a resin containing a fluorine atom (F).

It can be said that the porous layer itself may be a self-supporting film. Therefore, an embodiment of the present invention also encompasses a separator consisting only of the above-described porous layer.

A porous layer described in the present specification as a porous layer included in a separator in accordance with an embodiment of the present invention may be a porous layer for an electrochemical device. The purpose of the use of the porous layer is not limited to this. For example, the porous layer may be used as a separation film, a substrate, a protective film, and the like.

The nitrogen-containing resin is preferably at least one selected from a group consisting of polyamide, polyamide imide, and polyimide. Further, the nitrogen-containing resin can be a nitrogen-containing aromatic resin. A nitrogen-containing aromatic resin means an aromatic resin containing a nitrogen atom. An aromatic resin means a resin containing a structural unit having at least an aromatic group. Examples of the nitrogen-containing aromatic resin include aromatic polyamides such as a wholly aromatic polyamide (aramid resin) and a semi-aromatic polyamide, aromatic polyimides, aromatic polyamide imides, polybenzimidazoles, aromatic polyurethanes, and melamine resins. In particular, the nitrogen-containing aromatic resin preferably includes an aramid resin.

Examples of the aramid resin include para-aramids and meta-aramids. Among these, para-aramids are more preferable. Examples of the para-aramids include para-aramids each having a para-oriented structure or a quasi-para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), a paraphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer. Examples of the meta-aramids include poly(metaphenylene terephthalamide), poly(metaphenylene isophthalamide), poly(metabenzamide), poly(metaphenylene-4,4′-biphenylene dicarboxylic acid amide), and poly(metaphenylene-2,6-naphthalene dicarboxylic acid amide). Poly(metaphenylene isophthalamide) is also referred to as poly [N,N′-(1,3-phenylene) isophthalamide].

Examples of the fluorine-containing resins include polyvinylidene fluoride (PVdF), polytetrafluoroethylene, a vinylidene fluoride-hexafluoropropylene copolymer, a tetrafluoroethylene-hexafluoropropylene copolymer, a tetrafluoroethylene-perfluoroalkylvinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins include fluorine-containing rubber having a glass transition temperature of not higher than 23° C.

The porous layer preferably contains at least one resin selected from a group consisting of polyamide, polyamide imide, polyimide, and polyvinylidene fluoride among the resins listed above and more preferably contains an aramid resin as the polyamide.

The resin is not particularly limited and is preferably two or more resins having different deposition properties during forming of the porous layer. As described later, using two or more resins having different deposition properties as the resin makes it possible to suitably prepare a porous layer included in a separator in which the value expressed by the formula (1) is less than 0.05. Note here that the two or more resins having different deposition properties means two or more resins having different degrees of solubility in a solvent in a coating solution that is used to form the porous layer. The coating solution is a liquid obtained by dissolving and/or dispersing, in the solvent, a constituent material of the porous layer containing the resin. The two or more resins having different deposition properties with respect to a solvent in which the resin is dissolved preferably include, for example, two or more nitrogen-containing aromatic resins having different deposition properties. As the two or more resins having different deposition properties, it is preferable to combine resins having different structures, such as a resin having a rigid structure and a resin having flexibility. For example, poly(paraphenylene terephthalamide), poly(2-chloro-paraphenylene terephthalamide), poly(parabenzamide), and poly(4,4′-benzanilide terephthalamide) have a rigid structure. In contrast, poly(4,4′-diphenylsulfonyl terephthalamide), a paraphenylene terephthalamide/4,4′-diphenylsulfonyl terephthalamide copolymer, and a meta-aramid have flexibility. Note, however, that a combination of the two or more resins having different deposition properties is not limited to these combinations. The combination of the two or more resins having different deposition properties may be, for example, a combination of resins having relatively close structures, such as a combination of poly(paraphenylene terephthalamide) and poly(2-chloro-paraphenylene terephthalamide).

In addition, examples of a preferable resin other than the two or more resins having different deposition properties as the above-described resin include at least one resin having a wide molecular weight distribution. As described later, in a case where at least one resin having a wide molecular weight distribution is used as the resin, it is also possible to suitably prepare a porous layer included in a separator in which the value expressed by the formula (1) is less than 0.05.

Furthermore, even in a case where at least one resin having a narrow molecular weight distribution, which is a resin other than the above-described preferable resin, is used, changing a humidity in a deposition tank over time makes it possible to suitably prepare a porous layer included in a separator in which the value expressed by the formula (1) is less than 0.05, as described later.

A proportion of a nitrogen-containing aromatic resin in 100% by weight of a resin contained in the porous layer is preferably more than 50% by weight, more preferably not less than 70% by weight, and still more preferably not less than 90% by weight. The proportion of the nitrogen-containing aromatic resin in 100% by weight of the resin contained in the porous layer may be not more than 100% by weight, or may be less than 100% by weight. The resin contained in the porous layer particularly preferably consists only of a nitrogen-containing aromatic resin.

The porous layer may contain a nitrogen-containing aromatic resin and a resin other than the nitrogen-containing aromatic resin. A proportion of the resin other than the nitrogen-containing aromatic resin in 100% by weight of the resin contained in the porous layer is preferably less than 50% by weight, more preferably not more than 30% by weight, and still more preferably not more than 10% by weight. The proportion of the resin other than the nitrogen-containing aromatic resin in 100% by weight of the resin contained in the porous layer may be not less than 0% by weight, or may be more than 0% by weight.

Examples of the resin other than the nitrogen-containing aromatic resin include polyolefin-based resins; (meth)acrylate-based resins; fluorine-containing resins; polyester-based resins; rubbers; resins each having a melting point or a glass transition temperature of not lower than 180° C.; water-soluble polymers; polycarbonates; and polyacetals. In an embodiment, the resin contained in the porous layer can be a resin that is not a polyester-based resin.

Examples of the polyester-based resins include aromatic polyesters such as a polyarylate and liquid crystal polyesters.

Examples of the rubbers include a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, polyether amide, and polyether ether ketone.

Examples of the water-soluble polymers include polyvinyl alcohol, polyethylene glycol, cellulose ether, sodium alginate, polyacrylic acid, polyacrylamide, and polymethacrylic acid.

The porous layer can be a heat-resistant layer. The heat-resistant layer means a layer having a higher melting temperature than a substrate. The resin contained in the porous layer can be a resin having heat resistance. The resin having heat resistance can be a resin having a higher melting point or glass transition temperature than a resin constituting the substrate. The resin contained in the porous layer is preferably a resin that is insoluble in an electrolyte of the electrochemical device and that is electrochemically stable when the electrochemical device is in normal use.

The porous layer can contain a filler. The filler can be an inorganic filler or an organic filler. The filler is preferably a filler made of an inorganic oxide such as silica, calcium oxide, magnesium oxide, titanium oxide, alumina, mica, zeolite, aluminum hydroxide, or boehmite, more preferably a filler made of calcium oxide, magnesium oxide, or alumina, and still more preferably a filler made of alumina.

A filler content in 100% by weight of the porous layer is preferably not less than 0% by weight and less than 20% by weight, more preferably 0% by weight to 15% by weight, still more preferably 0% by weight to 10% by weight, and particularly preferably 0% by weight to 5% by weight. A filler content of 0% by weight means that the porous layer does not contain the filler. In order to ensure ion permeability, the filler content in 100% by weight of the porous layer may be more than 0% by weight, or may be not less than 1% by weight.

The filler has an average particle diameter of preferably not more than 1 μm, more preferably not more than 800 nm, still more preferably not more than 500 nm, still more preferably not more than 100 nm, and still more preferably not more than 50 nm. The average particle diameter of the filler has a lower limit that is not particularly limited and that can be, for example, 5 nm. Note here that the average particle diameter of the filler is an average value of sphere equivalent particle diameters of 50 particles of the filler. Further, the sphere equivalent particle diameters of the filler are values obtained by actual measurement with use of a transmission electron microscope. The following is a specific example of a measurement method.
1. An image of the filler is captured by using a transmission electron microscope (TEM; JEOL Ltd., transmission electron microscope JEM-2100F) at an acceleration voltage of 200 kV and at a magnification ratio of 10,000 times with use of a Gatan Imaging Filter.
2. In the image thus obtained, an outline of a particle is traced by using image analysis software (ImageJ) and a sphere equivalent particle diameter of a filler particle (primary particle) is measured.
3. The above measurement is carried out for 50 filler particles that have been randomly extracted. An arithmetic average of sphere equivalent particle diameters of the 50 filler particles is regarded as the average particle diameter of the filler.

In order to ensure adhesion of the porous layer to an electrode and a high energy density, the porous layer has a thickness per layer of preferably 0.15 μm to 5 μm, more preferably 0.25 μm to 5 μm, and still more preferably 0.35 μm to 3 μm. The porous layer having a thickness per layer of not less than 0.15 μm (i) makes it possible to sufficiently prevent or reduce an internal short circuit which might occur due to, for example, breakage of the electrochemical device and (ii) allows the porous layer to retain an electrolyte in an adequate amount. Meanwhile, in a case where the porous layer has a thickness per layer of not more than 5 μm, in the electrochemical device, it is possible to minimize metal ion permeability resistance, and thus it is possible to minimize a decrease in rate characteristic and in cycle characteristic. Further, in a case where the porous layer has a thickness per layer of not more than 5 μm, it is also possible to minimize an increase in distance between the positive electrode and the negative electrode. This makes it possible to minimize a reduction in internal volume efficiency of the electrochemical device. The thickness per layer of the porous layer is not limited to a thickness in the above-described range. For example, in a case where the porous layer is used without being formed on a substrate, the thickness per layer of the porous layer may be 0.3 μm to 35 μm or may be 5.5 μm to 35 μm.

A weight per unit area of the porous layer can be determined as appropriate in view of the strength, thickness, weight, and handleability of the porous layer. The weight per unit area per layer of the porous layer is preferably not less than 0.15 g/m² and more preferably not less than 0.25 g/m². The weight per unit area per layer of the porous layer may be not less than 0.3 g/m² or may be not less than 0.5 g/m². The weight per unit area per layer of the porous layer may be not more than 30 g/m², preferably not more than 10 g/m², and more preferably not more than 5 g/m². The porous layer having a weight per unit area in the above numerical ranges allows the electrochemical device to have a higher weight energy density and a higher volume energy density.

Pores of the porous layer have a diameter of preferably not more than 1.0 μm, and more preferably not more than 0.5 μm. In a case where the pores have such a diameter, the electrochemical device can achieve sufficient ion permeability.

Specifically, the air permeability of the porous layer has an upper limit of preferably not more than 120 sec/100 mL, and more preferably not more than 110 sec/100 mL. Further, the air permeability of the porous layer has a lower limit that is a value of more than 0 sec/100 cc. Ordinarily, the air permeability of the porous layer may be not less than 10 sec/100 cc or may be not less than 20 sec/100 cc. Note that the air permeability of the porous layer can be calculated by, for example, a method described in Examples.

In an embodiment of the present invention, the separator includes a polyolefin porous substrate, and the porous layer is formed on the polyolefin porous substrate. That is, in an embodiment of the present invention, the separator is a separator in which the porous layer and the polyolefin porous substrate are formed on top of each other. In the present specification, such a separator is also referred to as a laminated separator. The porous layer can be formed on one surface of the polyolefin porous substrate or on both surfaces of the polyolefin porous substrate.

The polyolefin porous substrate means a porous substrate that contains a polyolefin-based resin as a main component. The phrase “contain a polyolefin-based resin as a main component” means that the polyolefin-based resin is contained, in the porous substrate, at a proportion of not less than 50% by weight, preferably not less than 90% by weight, and more preferably not less than 95% by weight with respect to all materials that constitute the porous substrate. The porous substrate can be a polyolefin porous film.

The polyolefin-based resin more preferably contains a high molecular weight component having a weight-average molecular weight of 5×10⁵ to 15×10⁶. In particular, the polyolefin-based resin that contains a high molecular weight component having a weight-average molecular weight of not less than 1,000,000 is more preferable because such a polyolefin-based resin allows a resulting separator to have increased strength.

The polyolefin-based resin is exemplified by, but not particularly limited to, thermoplastic resins each obtained by polymerizing a monomer(s) such as ethylene, propylene, 1-butene, 4-methyl-1-pentene, 1-hexene, and/or the like, such as homopolymers and copolymers. Examples of the homopolymers include polyethylene, polypropylene, and polybutene. Examples of the copolymers include an ethylene-propylene copolymer.

Among the above examples of polyolefin-based resins, polyethylene is more preferable because polyethylene makes it possible to prevent a flow of an excessively large electric current to a separator at a lower temperature. Note that preventing the flow of an excessively large electric current is also referred to as “shutdown”. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is still more preferable.

The porous substrate has a thickness of preferably 4 μm to 40 μm, and more preferably 5 μm to 20 μm. The porous substrate having a thickness of not less than 4 μm makes it possible to sufficiently prevent an internal short circuit in the electrochemical device. Meanwhile, the porous substrate having a thickness of not more than 40 μm makes it possible to prevent an increase in size of the electrochemical device.

A weight per unit area of the porous substrate can be determined as appropriate in view of the strength, thickness, weight, and handleability of the porous substrate. Note, however, that the weight per unit area is preferably 4 g/m² to 20 g/m², more preferably 4 g/m² to 12 g/m², and still more preferably 5 g/m² to 10 g/m², so as to allow the electrochemical device to have a higher weight energy density and a higher volume energy density.

The porous substrate has therein many pores connected to one another. This allows a gas and a liquid to pass through the porous substrate from one side to the other side. The porous substrate has an air permeability of preferably 30 s/100 mL to 500 s/100 mL, and more preferably 50 s/100 mL to 300 s/100 mL. The porous substrate having the above air permeability can have sufficient ion permeability.

The porous substrate has a porosity of preferably 20% by volume to 80% by volume, and more preferably 30% by volume to 75% by volume, so as to (i) retain a larger amount of an electrolyte and (ii) obtain the function of reliably preventing a flow of an excessively large electric current at a lower temperature. In order to achieve sufficient ion permeability and prevent particles from entering the positive electrode and/or the negative electrode, the porous substrate has pores each having a pore diameter of preferably not more than 0.3 μm, and more preferably not more than 0.14 μm.

The separator has a thickness of preferably 5.5 μm to 45 μm, and more preferably 6 μm to 25 μm. The separator having a thickness of not less than 5.5 μm makes it possible to sufficiently prevent an internal short circuit in the electrochemical device. Meanwhile, the separator having a thickness of not more than 45 μm makes it possible to prevent an increase in size of the electrochemical device.

The separator may include, as necessary, another functional layer different from the above-described porous substrate and the above-described porous layer (e.g., heat-resistant layer), provided that the object of the present invention is not prevented from being attained. Examples of the another functional layer include known porous layers such as an adhesive layer and a protective layer.

The another functional layer can be provided on one surface of the separator or on both surfaces of the separator. In a case where the separator includes the above-described porous layer on both surfaces of the porous substrate, the another functional layer may be provided on the porous layer on both surfaces of the separator, or may be provided on the porous layer on one surface of the separator. In a case where the separator includes the above-described porous layer only on one surface of the porous substrate, the another functional layer may be provided on the porous layer, or may be provided on a surface of the porous substrate on which surface the porous layer is not provided. The another functional layer can be provided on an outermost layer of the separator.

For example, the separator further includes an adhesive layer separately from the above-described porous substrate and the above-described porous layer. In the present specification, the adhesive layer means a porous layer having adhesiveness. The adhesive layer can be provided on a surface of the separator which surface is in contact with the electrode. Examples of a component that is contained in the adhesive layer and that contributes to adhesiveness include an acrylic resin and PVdF.

### [2. Method for Producing Separator]

The porous layer can be formed with use of a coating solution obtained by dissolving or dispersing a resin in a solvent. Note that the solvent can be described as being a dispersion medium in which a resin is dispersed. Examples of the resin include the above-listed nitrogen-containing aromatic resins and the above-listed resins other than the nitrogen-containing aromatic resins. Examples of a method for forming the coating solution include a mechanical stirring method, an ultrasonic dispersion method, a high-pressure dispersion method, and a media dispersion method.

The porous layer can be formed by, for example, (i) a method of applying the coating solution directly to a surface of a substrate and then removing the solvent, (ii) a method of applying the coating solution to an appropriate support, subsequently removing the solvent so as to form a porous layer, pressure-bonding the porous layer to the substrate, and peeling the support off, (iii) a method of applying the coating solution to a surface of an appropriate support, pressure-bonding the substrate to that surface, peeling the support off, and then removing the solvent, or (iv) a method of carrying out dip coating by immersing the substrate into the coating solution, and then removing the solvent.

The solvent preferably (i) does not have an adverse effect on the substrate, (ii) allows the resin to be uniformly and stably dissolved in the solvent, and (iii) allows the filler to be uniformly and stably dispersed in the solvent. Examples of the solvent include N-methyl-2-pyrrolidone (NMP), N,N-dimethylacetamide, N,N-dimethylformamide, acetone, and water.

The coating solution may contain a filler. As necessary, the coating solution may contain, as a component(s) other than the resin and the filler, for example, a disperser, a plasticizer, a surfactant, and/or a pH adjuster.

The coating solution can be applied to the substrate by a conventionally known method. Specific examples of such a method include a gravure coater method, a dip coater method, a bar coater method, and a die coater method.

In a case where the coating solution contains an aramid resin, the aramid resin can be deposited by applying moisture to a surface to which the coating solution is applied. The porous layer may be formed in this way. A specific method of applying moisture to the surface to which the coating solution is applied is exemplified by, but not particularly limited to, a method of exposing the surface to a high-humidity atmosphere, a method of spraying water with use of a spray or the like, and a method of blowing water vapor via a nozzle or the like.

In particular, a method for producing a laminated separator can be, for example, a method in which, in a method for producing the above-described porous layer, the above-described porous substrate is used as a substrate to which the coating solution is applied.

A method for producing the porous substrate is not particularly limited. For example, a polyolefin resin composition in sheet form is produced by kneading a polyolefin-based resin together with a pore forming agent such as an inorganic bulking agent or a plasticizer, and optionally with another agent(s) such as an antioxidant, and then extruding the kneaded substances. The pore forming agent is then removed from the polyolefin resin composition in sheet form with use of a suitable solvent. Thereafter, the porous substrate can be produced by stretching the polyolefin-based resin composition from which the pore forming agent has been removed.

The inorganic bulking agent is exemplified by, but not particularly limited to, an inorganic filler, specific examples of which include calcium carbonate. The plasticizer is exemplified by, but not particularly limited to, a low molecular weight hydrocarbon such as liquid paraffin.

For example, satisfying the following conditions (i) to (iii) makes it possible to suitably produce a separator in which the value expressed by the formula (1) is in the above-described range.
(i) As the coating solution, a coating solution that has a low filler content or that contains no filler is used;
(ii) As the resin in the coating solution, a resin including two or more resins having different deposition properties or containing two or more components having different deposition properties is used; and
(iii) The resin is deposited for a short time.

In a case where the condition (i) is satisfied, an obtained porous layer has a low filler content [% by weight] and a high resin content [% by weight] with respect to a total weight of the porous layer. Thus, satisfying the condition (i) makes it possible to make the above-described A high.

In contrast, it is commonly known that, in a case where the condition (i) is satisfied, that is, in a case where a coating solution has a low filler content or contains no filler, the above-described B, that is, the porosity of the porous layer, becomes low. However, the inventors of present invention found that, in a case where not only the condition (i) but also the condition (ii) are satisfied, a porous layer has a high porosity.

Such a mechanism can be considered as being the following mechanism, though speculative. In a case where the condition (ii) is satisfied, in the process of deposition, a resin or component (first resin or first component) that has a high deposition property and that is easily deposited is deposited earlier, whereas a resin or component (second resin or second component) that has a low deposition property and that is not easily deposited is deposited later. Due to compatibility between the first resin or the first component and a solvent, the second resin or the second component is deposited near the first resin or the first component that has been deposited earlier. It is considered that the resins or components thus deposited so as to be unevenly distributed allow open pores to be sufficiently formed even without using a filler or even in a case where a filler content is reduced as compared with a conventional filler content. Therefore, it is considered that, in a case where not only the condition (i) but also the condition (ii) are satisfied, the above-described mechanism makes it possible to make the above-described A high and make the above-described B high.

Note here that the two or more resins having different deposition properties can be, for example, two or more resins having different degrees of solubility in a solvent in the coating solution. Further, a deposition property of a resin can vary depending on the molecular weight of the resin. Therefore, a resin containing two or more components having different deposition properties can be, for example, a resin having a wide molecular weight distribution. That is, using at least one resin having a wide molecular weight distribution makes it possible to suitably produce a separator in which the value expressed by the formula (1) is in the above-described range.

Further, the inventors of the present invention found that, in a case where the condition (iii) is satisfied, that is, in a case where a resin is deposited for a short time, it is possible to increase the porosity of a porous layer and make air permeabilities of the porous layer and a separator low. Such a mechanism can be considered as being the following mechanism, though speculative. It is considered that, in a case where a resin is deposited for a long time, there is a possibility that deposition of the resin continues even after pores are formed in a porous layer in an early stage of deposition, and a resin deposited after the pores have been formed blocks the pores. In addition, it is considered that, in a case where a resin is deposited for a long time, there is a possibility that the coating solution enters voids in the porous substrate in an interface between the porous substrate and the porous layer before the resin is deposited, and, after the coating solution has entered the voids, a resin is deposited from the coating solution. In that case, it is considered that there is a possibility that the resin deposited from the coating solution which has entered the voids blocks the voids.

Meanwhile, it is considered that, in a case where the condition (iii) is satisfied, it is possible to suitably prevent the above-described blockage of pores and voids, and as a result, it is possible to increase the porosity of a porous layer and make air permeabilities of the porous layer and a separator low. Thus, satisfying the condition (iii) makes it possible to make the above-described B high and make the above-described C low.

Further, it is considered that satisfying the following condition (iv) instead of satisfying the condition (ii) makes it possible to make the above-described A high and make the above-described B high.
(iv) As a deposition method, a humidity in a deposition tank is changed over time.

Note here that it is considered that changing a humidity in a deposition tank over time changes a deposition speed in an early stage and a late stage, and a mechanism similar to the mechanism provided in a case where the condition (ii) is satisfied makes it possible to make the above-described A high and make the above-described B high.

As described above, satisfying the conditions (i) to (iii) adjusts the value expressed by the formula (1) to a low value and thus makes it possible to suitably produce a separator in accordance with an embodiment of the present invention. Further, even in a case where the condition (ii) is not satisfied, satisfying the condition (iv) in addition to the conditions (i) and (iii) makes it possible to suitably produce a separator in accordance with an embodiment of the present invention. Specifically, the case where the condition (ii) is not satisfied includes a case where at least one resin having a narrow molecular weight distribution is used.

Further, in a case where the separator is a laminated separator, using a porous substrate having a low value of air permeability as the porous substrate included in the laminated separator makes it possible to make a value of air permeability of the entire separator, i.e. the above-described C, low. As a result, the value expressed by the formula (1) is adjusted to a low value, and it is also possible to more suitably produce a separator in accordance with an embodiment of the present invention.

### [3. Material, Electrochemical Device]

A material in accordance with an embodiment of the present invention includes a positive electrode, a separator described above, and a negative electrode, the positive electrode, the separator, and the negative electrode being arranged in this order. An electrochemical device in accordance with an embodiment of the present invention includes a separator described above.

Examples of the electrochemical device include a secondary battery and a capacitor. Examples of the secondary battery include a nonaqueous electrolyte secondary battery such as a lithium ion secondary battery. Examples of the capacitor include an electric double layer capacitor. A nonaqueous electrolyte secondary battery is not particularly limited in shape and can have any shape such as the shape of a thin plate (sheet), a disk, a cylinder, or a prism such as a cuboid.

For example, the material can be formed by arranging the positive electrode, the above-described separator, and the negative electrode in this order. The porous layer can be provided between the porous substrate and at least one of the positive electrode and the negative electrode. The material is then placed in a container that serves as a housing for the electrochemical device. In this manner, it is possible to produce the electrochemical device. In the case of a nonaqueous electrolyte secondary battery, the container is filled with a nonaqueous electrolyte (described later) and then hermetically sealed while pressure is reduced in the container.

### <Positive Electrode>

The positive electrode is not limited to any particular one, provided that the positive electrode is one that is generally used as a positive electrode of an electrochemical device. Examples of the positive electrode include a positive electrode sheet having a structure in which an active material layer containing a positive electrode active material and a binding agent is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include a lithium-containing complex metal oxide containing lithium (Li) and at least one transition metal selected from the group consisting of V, Cr, Mn, Fe, Co, Ni, Cu, and Al. Examples of such a lithium-containing complex metal oxide include LiCoO₂, LiNiO₂, LiMn₂O₄, Li₂MnO₃, LiNiₓMn_{y}Co_{1-x-y}O₂[0<x+y<1], LiNiₓCo_{y}Al_{1-x-y}O₂[0<x+y<1], LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄.

Examples of the electrically conductive agent include carbonaceous materials such as natural graphite, artificial graphite, cokes, carbon black (e.g., acetylene black), pyrolytic carbons, fibrous carbon materials, and fired products of and organic polymer compounds. Each of the above electrically conductive agents may be used alone. Alternatively, two or more of the above electrically conductive agents may be used in combination. A proportion of the electrically conductive agent in a positive electrode mix is preferably not less than 5 parts by mass and not more than 20 parts by mass with respect to 100 parts by mass of the positive electrode active material. The proportion can be reduced in a case where a fibrous carbon material such as graphitized carbon fiber or a carbon nanotube is used as the electrically conductive agent.

The binding agent can be a thermoplastic resin. Examples of the thermoplastic resin include fluorine-based resins such as PVdF, polytetrafluoroethylene (PTFE), a tetrafluoroethylene-hexafluoropropylene-vinylidene fluoride-based copolymer, a hexafluoropropylene-vinylidene fluoride-based copolymer, and a tetrafluoroethylene-perfluorovinyl ether-based copolymer, acrylic resins, styrene butadiene rubber, polyimide resins, and polyolefin resins. Note that the binding agent serves also as a thickener. It is possible to use a mixture of two or more of these thermoplastic resins. A positive electrode mix that has both great adhesion to the positive electrode current collector and a high bonding strength inside the positive electrode mix can be obtained by using a fluorine-based resin and a polyolefin resin as a binder to adjust a ratio of the fluorine-based resin to all the positive electrode mix to not less than 1% by mass and not more than 10% by mass, and adjust a ratio of the polyolefin resin to all the positive electrode mix to not less than 0.1% by mass and not more than 2% by mass.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet include: a method in which the positive electrode active material, the electrically conductive agent, and the binding agent (positive electrode mix) are pressure-molded on the positive electrode current collector; and a method in which (i) the positive electrode mix is formed into a paste with use of an appropriate organic solvent, (ii) the positive electrode current collector is coated with the paste, and (iii) the paste is dried and then pressure is applied so that the paste is firmly fixed to the positive electrode current collector.

Examples of an organic solvent that can be used in the above method include: amine-based solvents such as N,N-dimethylaminopropylamine and diethylenetriamine; ether-based solvents such as tetrahydrofuran; ketone-based solvents such as methyl ethyl ketone; ester-based solvents such as methyl acetate; and amide-based solvents such as dimethylacetamide and NMP.

Examples of a method of applying a paste of the positive electrode mix to the positive electrode current collector include a slit-die coating method, a screen coating method, a curtain coating method, a knife coating method, a gravure coating method, and an electrostatic spray method.

### <Negative Electrode>

The negative electrode is not limited to any particular one, provided that the negative electrode is one that is generally used as a negative electrode of an electrochemical device. Examples of the negative electrode include a negative electrode sheet having a structure in which an active material layer containing a negative electrode active material and a binding agent is formed on a negative electrode current collector. The active material layer may further contain an electrically conductive agent.

Examples of the negative electrode active material include materials each capable of being doped with and dedoped of metal ions such as lithium ions or sodium ions. Examples of the materials include materials which are carbonaceous materials, chalcogen compounds (such as oxides and sulfides), nitrides, metals, and alloys and each of which is capable of being doped with and dedoped of lithium ions at electric potentials lower than that of the positive electrode. Examples of the carbonaceous materials include natural graphite, artificial graphite, cokes, carbon black, and pyrolytic carbons.

Examples of the oxides that can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VOₓ (where x is a positive real number), such as V₂O₅ and VO₂; oxides of iron which are represented by a formula FeOₓ (where x is a positive real number), such as Fe₃O₄, Fe₂O₃, and FeO; oxides of tin which are represented by a formula SnOₓ (where x is a positive real number), such as SnO₂ and SnO; oxides of tungsten which are represented by a general formula WOₓ (where x is a positive real number), such as WO₃ and WO₂; and complex metal oxides each of which contains lithium and titanium or vanadium, such as Li₄TisO₁₂ and LiVO₂.

Examples of the sulfides that can be used as the negative electrode active material include: sulfides of titanium which are represented by a formula TiSₓ (where x is a positive real number), such as Ti₂S₃, TiS₂, and TiS; sulfides of vanadium which are represented by a formula VSₓ (where x is a positive real number), such as V₃S₄, VS₂, and VS; sulfides of iron which are represented by a formula FeSₓ (where x is a positive real number), such as Fe₃S₄, FeS₂, and FeS; sulfides of molybdenum which are represented by a formula MoSₓ (where x is a positive real number), such as Mo₂S₃ and MoS₂; sulfides of tin which are represented by a formula SnSₓ (where x is a positive real number), such as SnS₂ and SnS; sulfides of tungsten which are represented by a formula WSₓ (where x is a positive real number), such as WS₂; sulfides of antimony which are represented by a formula SbSₓ (where x is a positive real number), such as Sb₂S₃; and sulfides of selenium which are represented by a formula SeSₓ (where x is a positive real number), such as Se₅S₃, SeS₂, and SeS.

Examples of the nitrides that can be used as the negative electrode active material include lithium-containing nitrides such as Li₃N and Li₃₋ₓAₓN (where A is one or both of Ni and Co, and 0<x<3 is satisfied).

Each of these carbonaceous materials, oxides, sulfides, and nitrides may be used alone. Alternatively, two or more of these carbonaceous materials, oxides, sulfides, and nitrides may be used in combination. These carbonaceous materials, oxides, sulfides, and nitrides may be each crystalline or amorphous.

Examples of the metals that can be used as the negative electrode active material include lithium metals, silicon metals, and tin metals.

Examples of the alloys that can be used as the negative electrode active material include lithium alloys such as Li—Al, Li—Ni, Li—Si, Li—Sn, and Li—Sn—Ni; silicon alloys such as Si—Zn; tin alloys such as Sn—Mn, Sn—Co, Sn—Ni, Sn—Cu, and Sn—La; and alloys such as Cu₂Sb and La₃Ni₂Sn₇.

These metals and alloys are each mainly solely used as an electrode after being processed into, for example, foil form. Among the above-listed negative electrode active materials, a carbonaceous material that contains, as a main component, graphite such as natural graphite or artificial graphite is preferably used. This is because such a carbonaceous material hardly changes in electric potential of a negative electrode (has good potential evenness) from an uncharged state to a fully charged state during charging, has a low average discharge potential, and has a high capacity maintenance rate (has a good cycle characteristic) when charging and discharging are repeatedly carried out. The shape of the carbonaceous material may be, for example, any of the following: a flake shape like natural graphite; a spherical shape like mesocarbon microbeads; a fibrous shape like graphitized carbon fiber; an aggregate of fine powders; and the like.

Examples of the negative electrode current collector include Cu, Ni, and stainless steel. Among these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressure is applied so that the paste is firmly fixed to the negative electrode current collector. The paste preferably contains any of the above-listed electrically conductive agents and any of the above-listed binding agents.

The negative electrode sheet may contain a binder, as necessary. The binder can be, for example, a thermoplastic resin, specific examples of which include PVdF, thermoplastic polyimides, carboxymethyl cellulose, and polyolefin resins.

### <Nonaqueous Electrolyte>

A nonaqueous electrolyte is not limited to any particular one, provided that the nonaqueous electrolyte is one that is generally used for an electrochemical device, e.g., a nonaqueous electrolyte secondary battery. The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, LiN(SO₂C₂F₅)₂, LiN(SO₂CF₃)(COCF₃), Li(C₄F₉SO₃), Li₂B₁₀Cl₁₀, LiBOB (where BOB refers to bis(oxalato)borate), LiFSI (where FSI refers to bis(fluorosulfonyl)imide), lower aliphatic carboxylic acid lithium salt, and LiAlCl₄. Each of the above lithium salts may be used alone.

Alternatively, two or more of the above lithium salts may be used in combination. Among these electrolytes, it is preferable to use at least one fluorine-containing lithium salt selected from the group consisting of LiPF₆, LiAsF₆, LiSbF₆, LiBF₄, LiCF₃SO₃, LiN(SO₂CF₃)₂, and LiC(SO₂CF₃)₃.

Examples of the organic solvent include: carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and solvents each prepared by further introducing a fluoro group into any of these organic solvents (i.e., solvents each prepared by substituting one or more hydrogen atoms of any of these organic solvents with one or more respective fluorine atoms). Each of the above organic solvents may be used alone. Alternatively, two or more of the above organic solvents may be used in combination. In particular, a mixed solvent containing a carbonate is preferable, and a mixed solvent containing a cyclic carbonate and an acyclic carbonate, and a mixed solvent containing a cyclic carbonate and an ether are more preferable. The mixed solvent containing a cyclic carbonate and an acyclic carbonate is preferably a mixed solvent containing ethylene carbonate, dimethyl carbonate, and ethyl methyl carbonate. The electrolyte that contains such a mixed solvent has many advantages of having a wide operating temperature range, being less prone to deterioration even when subjected to charging and discharging at a high current rate, being less prone to deterioration even when used for a long period of time, and being less prone to decomposition even when the negative electrode active material is a graphite material such as natural graphite or artificial graphite.

The present invention is not limited to the embodiments, but can be altered by a skilled person in the art within the scope of the claims. The present invention also encompasses, in its technical scope, any embodiment derived by combining technical means disclosed in differing embodiments.

An embodiment of the present invention may include the following features.

<1> A separator for an electrochemical device, including a porous layer that contains a resin, wherein a value expressed by the following formula (1) is less than 0.05:

$$C / ( A \times B ) \qquad ( 1 )$$

where A is a resin content [% by weight] in the porous layer, B is a porosity [%] of the porous layer, and C is an air permeability [sec/100 mL] of the separator.
   <2> The separator described in <1>, wherein a value expressed by the following formula (2) is less than 3:

$$C / A \qquad ( 2 )$$

where A and C are identical to A and C in the formula (1).
   <3> The separator described in <1> or <2>, wherein a value expressed by the following formula (3) is more than 5200:

$$A \times B \qquad ( 3 )$$

where A and B are identical to A and B in the formula (1).
   <4> The separator described in any one of <1> to <3>, wherein the porous layer has a weight per unit area of not less than 0.15 g/m².
   <5> The separator described in any one of <1> to <4>, wherein the porous layer contains at least one resin selected from a group consisting of polyamide, polyamide imide, polyimide, and polyvinylidene fluoride.
   <6> The separator described in <5>, wherein the polyamide is an aramid resin.
   <7> The separator described in any one of <1> to <6>, further including a polyolefin porous substrate,
the porous layer being formed on the polyolefin porous substrate.
   <8> The separator described in <7>, further including an adhesive layer separately from the polyolefin porous substrate and the porous layer.
   <9> A material including a positive electrode, a separator described in any one of <1> to <8>, and a negative electrode, the positive electrode, the separator, and the negative electrode being arranged in this order.
   <10> An electrochemical device including a separator described in any one of <1> to <8>.
   <11> The electrochemical device described in <10>, wherein the electrochemical device is a secondary battery or a capacitor.

### EXAMPLES

The following description will discuss an example of the present invention.

### [Measurement and Evaluation of Physical Properties]

Physical properties of porous layers disclosed in Examples and Comparative Examples and separators disclosed in Examples and Comparative Examples were measured and evaluated by the following method.

### (Air Permeability)

An air permeability of a separator and an air permeability of a porous substrate were measured by the Gurley tester method in conformity with JIS P8117.

With use of measurement values of the air permeability of a separator and of the air permeability of a porous substrate, an air permeability of a porous layer was calculated in accordance with the following formula (4):

$$Air permeability of porous layer [ sec / 100 mL ] = air permeability of separator [ sec / 100 mL ] - air permeability of porous substrate [ sec / 100 mL ] \qquad ( 4 )$$

Note that, in the case of the separator produced in Example 3, which consists only of a porous layer, the “air permeability of porous substrate” in the formula (4) was “0”, and the air permeability of the porous layer was equal to the air permeability of the separator.

### (Porosity of Porous Layer)

A porosity of the porous layer was calculated by the following procedure.

Step 1. Parameters were Defined as Below.
Constituent materials of the porous layer: a, b, c, . . . , n
Respective weight ratios [% by weight] of constituent materials in the porous layer: Wa, Wb, We, . . . , Wn
Respective real densities [g/cm³] of constituent materials: da, db, de, . . . , dn
Thickness [cm] of the porous layer: t
Weight per unit area [g/cm²] of the porous layer: Z
   Step 2. From the Parameters Defined in Step 1, a Porosity ε[%] of a Porous Layer was Calculated in Accordance with the Following Equation (5):

$$ε [ \% ] = [ 1 - \{ Z \times ( Wa / da + Wb / db + Wc / dc + … + Wn / dn ) t \} ] \times 100 \qquad ( 5 )$$

Further, a density described in product information disclosed by a manufacturer was employed as a real density of the filler, a density described in Reference Document 1 below was employed as a real density of a resin X described later, and a density described in Reference Document 2 below was employed as a real density of a resin Y described later.

Reference Document 1: K Xiao et al., J. Mater. Sci. 27 (1992) 3065 Reference Document 2: Takashi NOMA “Properties and Application of Aramid Fibers” in Special issue on “Gousei sen'i no kaihatsu doukou [Trends in development of synthetic fibers]”. Sen'i Gakkaishi [Journal of Fiber Science and Technology](Sen'i To Kogyo), vol. 56, no. 8, pp. 241-247, 2,000

### (Thickness)

The thickness of each of the porous substrates used in Examples and Comparative Examples was measured in advance with use of a high-accuracy digital measuring instrument (manufactured by Mitutoyo Corporation). Specifically, each of the porous substrates was cut into a square piece with an 8 cm side, and measurement was carried out at five points in the square piece. The thickness was determined from an average value of measurements obtained at the five points.

Subsequently, the thickness of each of the separators produced in Examples and Comparative Examples was measured by a method identical to a method for measuring the thickness of the porous substrate.

The thickness of the porous layer constituting the separator was calculated with use of the measured thickness of the porous substrate and the measured thickness of the separator on the basis of the following equation (6):

$$Thickness [ μm ] of porous layer = thickness [ μm ] of separator - thickness [ μm ] of porous substrate \qquad ( 6 )$$

### (Weight Per Unit Area of Porous Layer)

A square sample measuring 8 cm×8 cm was cut out from the separator. A weight of this sample was measured and regarded as W1 [g]. A weight per unit area of the separator was calculated in accordance with the following equation (7):

$$Weight per unit area of separator [ g / {m}^{2} ] = W 1 [ g ] / ( 0.08 [ m ] \times 0.08 [ m ] ) \qquad ( 7 )$$

Further, a square sample measuring 8 cm×8 cm was cut out from a polyolefin porous film, which is a porous substrate to which a coating solution has not been applied. A weight of this sample was measured and regarded as W2 (g). A weight per unit area of the porous substrate was calculated in accordance with the following equation (8):

$$Weight per unit area of porous substrate [ g / {m}^{2} ] = W 2 [ g ] / ( 0.08 [ m ] \times 0.08 [ m ] ) \qquad ( 8 )$$

The measured weight per unit area of the separator and the measured weight per unit area of the porous substrate were used to calculate a weight per unit area of the porous layer in accordance with the following equation (9):

$$Weight per unit area of porous layer [ g / {m}^{2} ] = weight per unit area of separator [ g / {m}^{2} ] - weight per unit area of porous substrate [ g / {m}^{2} ] \qquad ( 9 )$$

### (Cycle Test)

A cycle test was carried out through the following procedure.
1. Stored in a coin battery container was a laminated body obtained by forming a spring, a spacer (having a thickness of 0.5 mm), a first lithium metal (having a diameter of 15 mm and a thickness of 0.5 mm, manufactured by Honjo Metal Co., Ltd.), two separators (having a diameter of 17 mm and disposed such that a porous layer of one of the two separators and the first lithium metal were in contact with each other and such that a porous layer of another one of the two separators and a second lithium metal were in contact with each other), the second lithium metal (having a diameter of 15 mm and a thickness of 0.5 mm, manufactured by Honjo Metal Co., Ltd.), and a spacer (having a thickness of 0.5 mm) on top of each other in this order from above.
2. 190 μL of a nonaqueous electrolyte was injected into the coin battery container in which the laminated body was stored, vacuum impregnation was carried out, and then 85 μL of the nonaqueous electrolyte was further injected into the coin battery container. Subsequently, the coin battery container was caulked and sealed. In this way, a coin battery was produced. The nonaqueous electrolyte was made up by dissolving LiPF₆ in a mixed solvent obtained by mixing ethylene carbonate, ethyl methyl carbonate, and diethyl carbonate at a ratio (volume ratio) of 3:5:2 so that the concentration of LiPF₆ in the nonaqueous electrolyte became 1 mol/L.
3. A cycle test was carried out by applying a constant current to the coin battery so that dissolution and deposition of the lithium metals were repeatedly carried out. The cycle test was carried out under conditions in which a current density of the constant current was 1.0 mA/cm², a period of time during which a single current application was carried out was 1 hour, a capacity was 1.0 mA/cm², and a temperature was 25° C.
4. The cycle test was ended when a voltage of the coin battery reached a cutoff value (±0.5 V) or when a short circuit occurred (the voltage reached 0 V). A time [h] that elapsed before the voltage reached the cutoff value (±0.5 V) was measured. Hereinafter, the measured time is referred to as “cycle time”.

### Synthesis Example 1: Synthesis of Resin X

The resin X (poly(4,4′-diphenylsulfonyl terephthalamide)) was synthesized by the following procedure.
1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, 31.97 g of 4,4′-diaminodiphenylsulfone was added at 100° C., and then a resulting mixture was completely dissolved.
4. A resulting solution was cooled to room temperature. While the temperature of the solution was maintained at 25±2° C., 25.88 g in total of terephthalic acid dichloride was added in 3 separate portions. 5. While the temperature of a resulting solution was maintained at 25±2° C., the solution was matured for 1 hour to obtain the solution that contained the resin X.

### Synthesis Example 2: Synthesis of Resin Y

The resin Y (poly(paraphenylene terephthalamide)) was synthesized by the following procedure.
1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, the temperature of a resulting solution was returned to room temperature. Subsequently, 13.20 g of paraphenylenediamine was added and completely dissolved.
4. While the temperature of a resulting solution was maintained at 25±2° C., 24.24 g in total of terephthalic acid dichloride was added in 3 separate portions.
5. While the temperature of a resulting solution was maintained at 25±2° C., the solution was matured for 1 hour to obtain the solution that contained the resin Y.

### Example 1

A separator including a porous layer that contained the resin X, the resin Y, and alumina at a weight ratio of 50:50:5 was produced. Specifically, a mixture (1) was obtained by mixing the solutions obtained in Synthesis Examples 1 and 2 so that the weight ratio between the resin X and the resin Y was 50:50. To 500 g of the mixture (1) thus obtained, 11.68 g of calcium carbonate was added. A resulting solution was stirred for 10 minutes so as to be neutralized. Thus, a neutralized solution (1) was obtained. Subsequently, alumina (average particle diameter: 13 nm) was added to the neutralized solution (1) so that the weight ratio among the resin X, the resin Y, and the alumina was 50:50:5, and a resulting solution was further diluted with NMP and defoamed under reduced pressure to prepare a coating solution (1) in slurry form. The coating solution (1) had a solid content concentration of 4.5% by weight.

The coating solution (1) was applied to a polyethylene porous film (thickness: 10.3 μm, air permeability: 180 s/100 mL) so that a porous layer (1) was deposited in a deposition tank at 50° C. and a humidity of 70%. Note that a deposition time was set to 10 seconds. Thereafter, the polyethylene porous film and the porous layer (1) were washed with water and dried to obtain a laminated separator including the porous layer (1). The laminated separator thus obtained was regarded as a separator (1). The porous layer (1) had a weight per unit area of 1.1 g/m².

### Example 2

A separator including a porous layer that contained no alumina and that contained the resin X and the resin Y at a weight ratio of 50:50 was produced. Specifically, operations were carried out in the same manner as in Example 1 to obtain a laminated separator including a porous layer (2), except that alumina (average particle diameter: 13 nm) was not added to the neutralized solution (1). The laminated separator thus obtained was regarded as a separator (2). The porous layer (2) had a weight per unit area of 1.5 g/m².

### Example 3

A separator consisting only of a porous layer that contained no alumina and that contained the resin X and the resin Y at a weight ratio of 90:10 was produced. Specifically, a mixture (2) was obtained by mixing the solutions obtained in Synthesis Examples 1 and 2 so that the weight ratio between the resin X and the resin Y was 90:10. To 500 g of the mixture (2) thus obtained, 17.8 g of calcium carbonate was added. A resulting solution was stirred for 10 minutes so as to be neutralized. Thus, a neutralized solution (2) was obtained. Subsequently, the neutralized solution (2) was diluted with NMP and defoamed under reduced pressure to prepare a coating solution (2) in slurry form. The coating solution (2) had a solid content concentration of 6.0% by weight.

The coating solution (2) was applied to a PET film (thickness of 75 μm) which had been subjected to mold releasing treatment, and the PET film to which the coating solution (2) was applied was treated in a deposition tank at 50° C. and a humidity of 70% for 5 minutes so that a porous layer (3) was deposited. Thereafter, the PET film and the porous layer (3) were washed with water and dried in a drying oven of 80° C. to obtain a laminated body consisting of the porous layer (3) and the PET film. Thereafter, the PET film was peeled away from the laminated body to obtain a porous film consisting only of the remaining porous layer (3). The porous film thus obtained itself was regarded as a separator (3). The porous layer (3) and the separator (3) are identical and had a weight per unit area of 12.5 g/m².

### Comparative Example 1

Operations were carried out in the same manner as in Example 1 to obtain a laminated separator including a porous layer (4), except for changes shown in (a) and (b) below. The laminated separator thus obtained was regarded as a comparative separator (1). The porous layer
(4) had a weight per unit area of 1.5 g/m².
(a) The deposition time was changed from 10 seconds to 30 seconds.
(b) The manner in which alumina was added to the neutralized solution (1) was changed so that the weight ratio among the resin X, the resin Y, and the alumina was 50:50:100.

### Comparative Example 2

Operations were carried out in the same manner as in Example 2 to obtain a laminated separator including a porous layer (5), except that the deposition time was changed from 10 seconds to 30 seconds. The laminated separator thus obtained was regarded as a comparative separator (2). The porous layer (5) had a weight per unit area of 1.7 g/m².

### [Results]

Tables 1 and 2 show production conditions in Examples and Comparative Examples, specifically, weight ratios of used raw materials and deposition time, and results of evaluation of the produced porous layers and the produced separators.

TABLE 1

| | | | | | | Evaluation result | | | | | | |
|---|---|---|---|---|---|---|---|---|---|---|---|---|
| | | | | | | Porous layer | | | | | Separator | |
| | Production condition | | | | | | | Air | | | | Air |
| | Weight ratio of raw | | | | | Resin | | perme- | | Weight | | perme- |
| | material | | | | | content | | ability | Thick- | per unit | Thick- | ability |
| | Resin | Resin | Filler | Deposition | | A [% by | Porosity | [sec/ | ness | area | ness | C [sec/ |
| | X | Y | (alumina) | time [sec] | Substrate | weight] | B [%] | 100 mL] | [μm] | [g/m²] | [μm] | 100 mL] |
| Example 1 | 50 | 50 | 5 | 10 | Present | 95.2 | 65.5 | 63 | 2.27 | 1.1 | 12.6 | 243 |
| Example 2 | 50 | 50 | 0 | 10 | Present | 100 | 59.8 | 96 | 2.67 | 1.5 | 13.0 | 276 |
| Example 3 | 50 | 50 | 0 | 900 | Absent | 100 | 52.2 | 34 | 19.0 | 12.5 | 19.0 | 34 |
| Comparative | 50 | 50 | 100 | 30 | Present | 50 | 73.4 | 36 | 3.00 | 1.5 | 13.3 | 216 |
| Example 1 | | | | | | | | | | | | |
| Comparative | 50 | 50 | 0 | 30 | Present | 100 | 54.8 | 144 | 2.77 | 1.7 | 13.1 | 324 |
| Example 2 | | | | | | | | | | | | |

TABLE 2

| | C/(A × B) | C/A | A × B | Cycle time [h] |
|---|---|---|---|---|
| Example 1 | 0.039 | 2.55 | 6235 | 309 |
| Example 2 | 0.046 | 2.76 | 5980 | 271 |
| Example 3 | 0.007 | 0.34 | 5220 | 399 |
| Comparative | 0.059 | 4.32 | 3672 | 235 |
| Example 1 | | | | |
| Comparative | 0.059 | 3.25 | 5476 | 229 |
| Example 2 | | | | |

The separators (1) to (3) each include a porous layer that contains a resin and are each such that C/(A×B) is less than 0.05 as shown in Table 2. Thus, the separators (1) to (3) each fall under the separator in accordance with an embodiment of the present invention.

Electrochemical devices including respective ones of the separators (1) to (3), which were produced in Examples 1 to 3, had a longer cycle time than that of an electrochemical device including respective ones of the comparative separator (1) and (2), which were produced respectively in Comparative Examples 1 and 2. Thus, it is shown that cycle characteristics of the electrochemical devices including the respective ones of the separators (1) to (3) are improved.

The above has proved that the separator in accordance with an embodiment of the present invention enables improvement of a cycle characteristic of an electrochemical device.

### INDUSTRIAL APPLICABILITY

An aspect of the present invention is applicable to an electrochemical device.

1. A separator for an electrochemical device, comprising a porous layer that contains a resin, wherein a value expressed by the following formula (1) is less than 0.05:
$$C / ( A \times B ) \qquad ( 1 )$$
where A is a resin content [% by weight] in the porous layer, B is a porosity [%] of the porous layer, and C is an air permeability [sec/100 mL] of the separator.

2. The separator of claim 1 wherein a value expressed by the following formula (2) is less than 3:
$$C / A \qquad ( 2 )$$
where A and C are identical to A and C in the formula (1).

3. The separator of claim 1, wherein a value expressed by the following formula (3) is more than 5200:
$$A \times B \qquad ( 3 )$$
where A and B are identical to A and B in the formula (1).

4. The separator of claim 1, wherein the porous layer has a weight per unit area of not less than 0.15 g/m².

5. The separator of claim 1, wherein the porous layer contains at least one resin selected from a group consisting of polyamide, polyamide imide, polyimide, and polyvinylidene fluoride.

6. The separator of claim 5, wherein the polyamide is an aramid resin.

7. The separator of claim 1, further comprising a polyolefin porous substrate,
the porous layer being formed on the polyolefin porous substrate.

8. The separator of claim 7, further comprising an adhesive layer separately from the polyolefin porous substrate and the porous layer.

9. A material comprising a positive electrode, a separator recited in claim 1, and a negative electrode, the positive electrode, the separator, and the negative electrode being arranged in this order.

10. An electrochemical device including a separator recited in claim 1.

11. The electrochemical device of claim 10, wherein the electrochemical device is a secondary battery or a capacitor.
